(19) United States
(12) Patent Application Publication
(10) Pub. No.: US 2015/0278748 A1
(43) Pub. Date: Oct. 1, 2015

(54) ROUTING TROUBLE TICKETS TO PROXY SUBJECT MATTER EXPERTS

(71) Applicant: INTERNATIONAL BUSINESS MACHINES CORPORATION, Armonk, NY (US)

(72) Inventors: ERIC M. ANDERSON, FRIENDSWOOD, TX (US); ROBERT A. DAVIS, ATLANTA, GA (US); CHRISTOPHER J. DAWSON, ARLINGTON, VA (US); RAJESH RADHAKRISHNAN, RESTON, VA (US)

(73) Assignee: INTERNATIONAL BUSINESS MACHINES CORPORATION, Armonk, NY (US)

(21) Appl. No.: 14/242,440

(22) Filed: Apr. 1, 2014

(51) Int. Cl. G06Q 10/06; G06Q 30/00

(52) U.S. Cl. CPC G06Q 10/063112; G06Q 30/016

(57) ABSTRACT

A method, system, and/or computer program product handles trouble tickets in a service unit. Friend members of a social network group to which a proxy Subject Matter Expert (SME) belongs are identified. Areas of expertise, which include expertise in a particular subject, that are held by the friend members of the social network group are identified, and then associated with the proxy SME. A trouble ticket related to the particular subject is received, and a primary SME that personally has a level of expertise to handle the trouble ticket is identified. In response to the primary SME being unavailable, the trouble ticket is transmitted to the proxy SME for handling by one or more of the friend members from the social network group to which the proxy SME belongs.

### BACKGROUND

The present disclosure relates to the field of computers, and specifically to the use of computers in handling service requests. Still more particularly, the present disclosure relates to routing trouble tickets to appropriate Subject Matter Experts (SMEs).

Enterprises often support hundreds of clients using a framework designed to route requests for assistance to appropriate resources, including a human resource. Such resources have different areas of expertise. Thus, requests for assistance are sent to a resource that has the appropriate expertise/knowledge/ability needed to handle a particular type of request. However, maintaining a listing of such areas of expertise and the persons who have them is impractical and/or impossible for a large enterprise, since 1) areas of expertise are always changing, and 2) personnel changes are commonplace. Furthermore, by narrowly defining a human resource according to his personal areas of expertise, such systems are unable to handle spikes in request traffic, since the resource pool is fixed and limited.

### SUMMARY

A method, system, and/or computer program product handles trouble tickets in a service unit. Friend members of a social network group to which a proxy Subject Matter Expert (SME) belongs are identified. Areas of expertise, which include expertise in a particular subject, that are held by the friend members of the social network group are identified, and then associated with the proxy SME. A trouble ticket related to the particular subject is received, and a primary SME that personally has a level of expertise to handle the trouble ticket is identified. In response to the primary SME being unavailable, the trouble ticket is transmitted to the proxy SME for handling by one or more of the friend members from the social network group to which the proxy SME belongs.

### BRIEF DESCRIPTION OF THE SEVERAL VIEWS OF THE DRAWINGS

FIG. 1 depicts an exemplary system and network in which the present disclosure may be implemented;

FIG. 2 illustrates a high-level overview of a trouble ticket handling system that uses a primary Subject Matter Expert (SME);

FIG. 3 depicts a high-level overview of a trouble ticket handling system that uses a proxy Subject Matter Expert (SME);

FIG. 4 illustrates an exemplary process for defining proxy expertise based on incidence rates of posts by members of the social media group depicted in FIG. 3;

FIG. 5 depicts additional detail of data mining of social media posts to identify certain areas of expertise; and

FIG. 6 is a high level flow-chart of one or more operations performed by one or more processors to selectively direct trouble tickets to either a primary SME or a proxy SME.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Today, issues may arise in a service desk environment that appear to be unique or requiring skills in a certain area that is not readily available. If the issue is centered around a well-known subject, it is routed to the appropriate group or person who represents that subject area. If it is not, the ticket is very frequently routed to many different groups and many different people until someone with knowledge in that very narrow area is assigned to resolve the issue. This causes quite a bit of delay in resolving issues. Furthermore, there is a vast amount of knowledge that is not currently utilized within the group of service agents' peers. That is, since handling trouble tickets (i.e., service tickets) is not part of these peers' job description, their ability to help in handling service calls is not utilized. Thus, the present invention provides a method, system, and/or computer product that mines social media, social networks and external user community sites to understand not only what kind of technology a particular service agent is familiar with, but also what kind of business and relationships that agent has with subject matter experts (whose job description may or may not include handling requests for assistance from customers) that might be leveraged. The present invention also overcomes the problem of fixed systems, such as a database describing interests, skills, classes, etc. of human resources, which becomes out of date very rapidly.

Note that the terms “social media” and “social websites” are utilized interchangeably herein, and are defined as on-line services that allow individuals, corporations, and other entities to electronically communicate in a controlled (via a social media service) community environment. The terms “media group” and “social media group” are likewise used interchangeably, and are defined as a predefined group of entities within a social website.

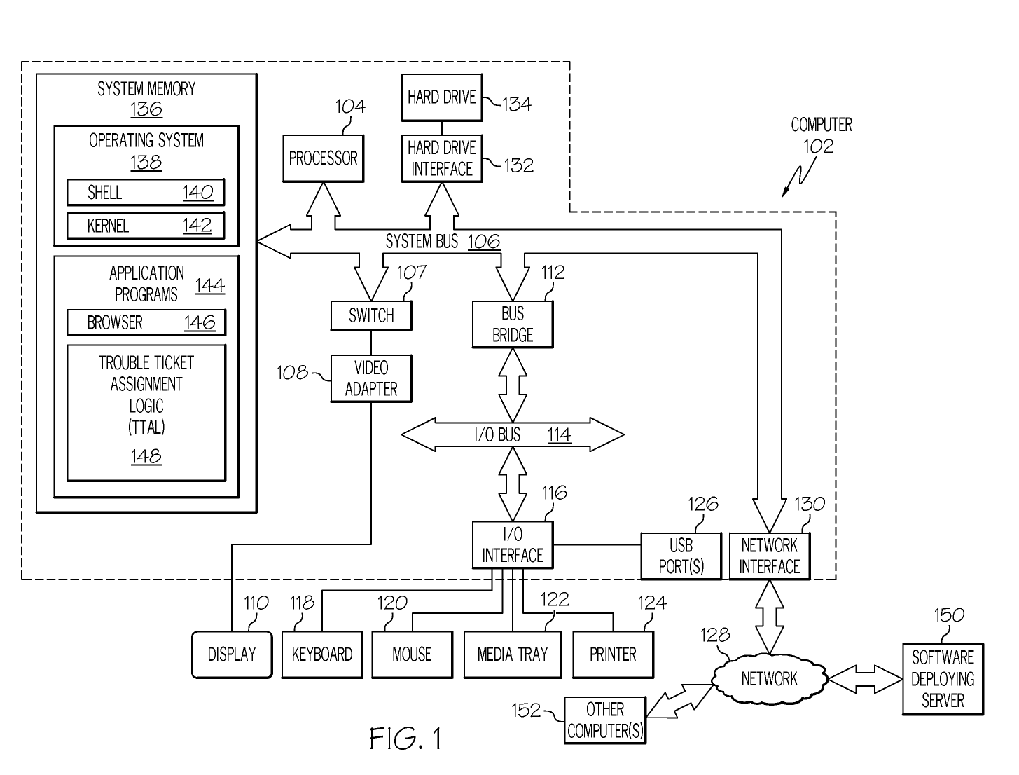

With reference now to the figures, and in particular to FIG. 1, there is depicted a block diagram of an exemplary system and network that may be utilized by and/or in the implementation of the present invention. Note that some or all of the exemplary architecture, including both depicted hardware and software, shown for and within computer 102 may be utilized by software deploying server 150 and/or other computer(s) 152.

Exemplary computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150, using a network interface 130. Network interface 130 is a hardware network interface, such as a network interface card (NIC), etc. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

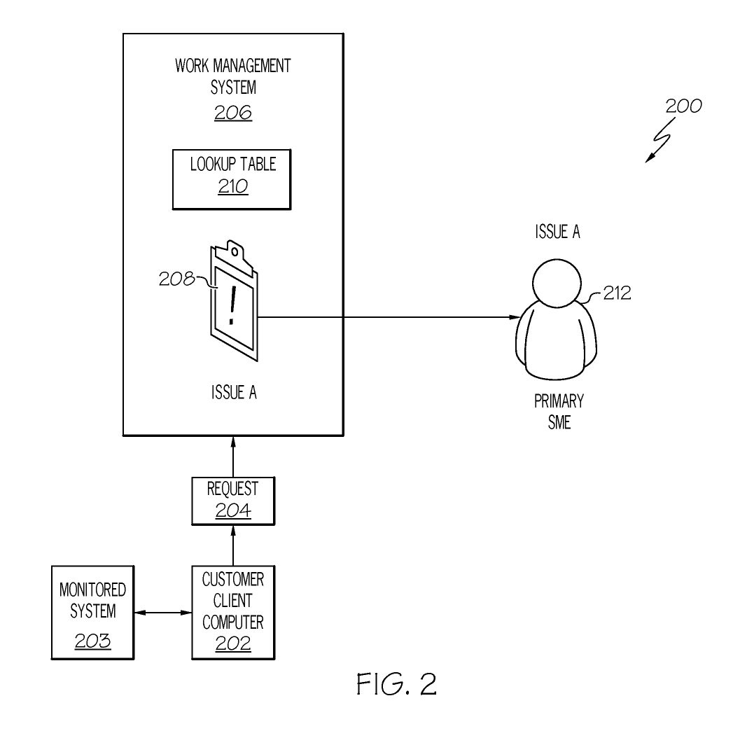

Application programs 144 in computer 102's system memory (as well as software deploying server 150's system memory) also include a Trouble Ticket Assignment Logic (TTAL) 148. TTAL 148 includes code for implementing the processes described below, including those described in FIGS. 2-6. In one embodiment, computer 102 is able to download TTAL 148 from software deploying server 150, including in an on-demand basis, wherein the code in TTAL 148 is not downloaded until needed for execution. Note further that, in one embodiment of the present invention, software deploying server 150 performs all of the functions associated with the present invention (including execution of TTAL 148), thus freeing computer 102 from having to use its own internal computing resources to execute TTAL 148.

Note that the hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

With reference now to FIG. 2, a high-level overview of a trouble ticket handling system that uses a primary Subject Matter Expert (SME) is presented. A customer, using a customer client computer 202 (e.g., one of the other computer(s) 152 depicted in FIG. 1), generates a request 204. Request 204 may be in the user-initiated form of a phone call, an e-mail, an on-line request (e.g., via a portal or webpage) in which the customer's problem/request is identified by a user/person, or the request 204 may be in the form of an automatic signal sent from the customer client computer 202. For example, customer client computer 202 may detect an anomaly (e.g., overheating, going off line, “crashing”, having inadequate memory to handle page swaps, etc.) in a monitored system 203 (e.g., a computer system, which may be one or more of the other computer(s) 152 depicted in FIG. 1). In this scenario, customer client computer 202 directly detects the anomaly in monitored system 203 (e.g., using hardware in customer client computer 202 that monitors one or more sensors in monitored system 203 that reflect operating conditions within monitored system 203). Note that such a detection cannot be made by a person, since it is based on an electronic signal that is sent directly from the sensor in monitored system 203 to hardware within customer client computer 202, and the request 204 is an electronic signal that is sent to the a Work Management System (WMS) 206. In one embodiment, WMS 206 is, or at least is a component of, computer 102 shown in FIG. 2.

In one embodiment, the request 204 itself is also only machine-interpretable, such as a voltage level, frequency, etc. of an electronic signal that is the request 204, and which is interpreted by hardware within WMS 206. That is, if request 204 is of a predefined voltage/frequency signal, the hardware within WMS 206 will interpret this predefined voltage/frequency signal as indicative of a specific problem/trouble with the monitored system 203.

Whether user-entered or automatically entered, request 204 may be a request to fix a problem with a computer (hardware or software), resolve a billing dispute, handle a legal issue such as complying with regulatory issues in a foreign country, etc. As depicted in FIG. 2, this request 204 is sent to the Work Management System (WMS) 206. WMS 206 is a system that drives work and assessments of tickets, works and problem records to individuals. That is, WMS 206 generates trouble tickets (where a “trouble ticket” is defined as a work order to handle a request for assistance from a customer), such as trouble ticket 208.

In the example shown in FIG. 2, trouble ticket 208 is in reference to a particular problem, shown as Issue A. WMS 206 maintains a system that allows it to “know” which SME is qualified (i.e., has the expertise) to handle the trouble ticket 208 (i.e., has expertise, knowledge, and/or experience in resolving problems related to Issue A). In one embodiment, a lookup table 210 matches the subject matter of the request to the expertise of different SMEs. If the request 204 was made by a person (i.e., via an e-mail, a phone call, an entry on a portal/webpage, etc.), then the subject matter of the request is determined by data mining the entry (e.g., from a subject line on an e-mail, using voice-to-text technology to identify key words in the phone call, identifying which option from a pull-down menu on a portal/webpage was selected, etc.). If request 204 was made by a machine (e.g., an electronic signal generated in response to an anomaly in monitored system 203), then the lookup table 210 matches a characteristic of the electronic signal (e.g., its voltage, frequency, communication protocol format, etc.) that makes up request 204 to a particular subject area (e.g., Issue A).

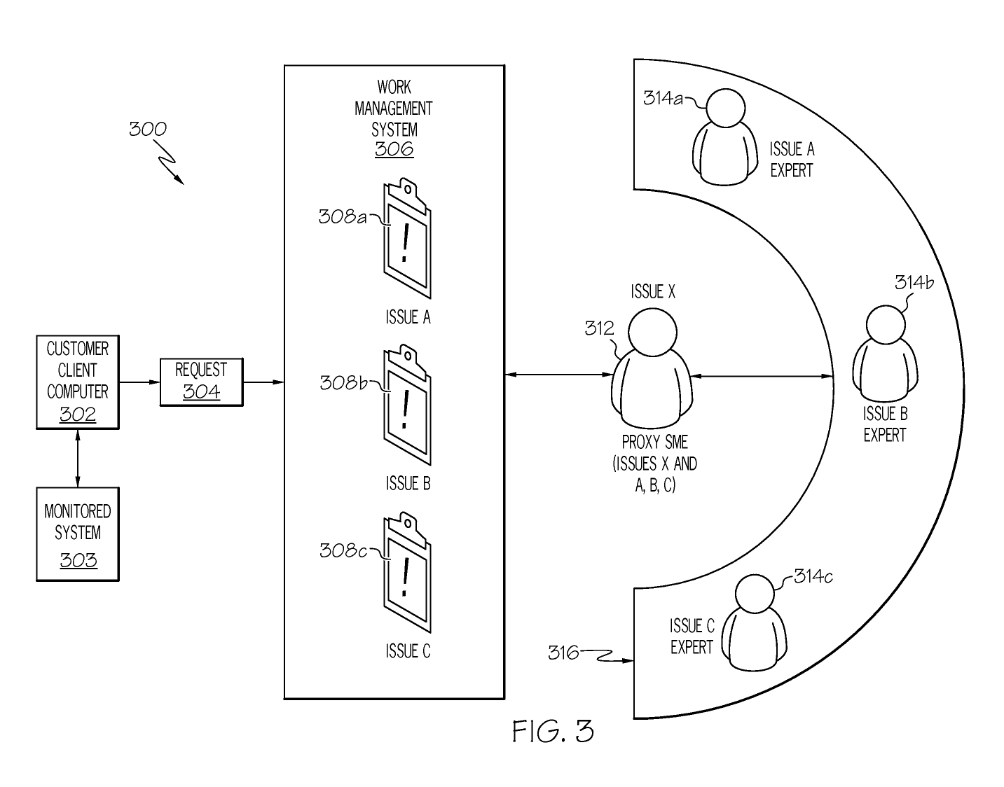

In the example shown in FIG. 2, the lookup table 210 has determined that primary SME 212 has the requisite expertise and/or experience to handle the trouble ticket 208 related to Issue A. Primary SME 212 is defined as an SME who has been assigned responsibility for responding to trouble tickets that relate to his/her particular area of expertise (e.g., in handling troubles related to Issue A). Thus, the trouble ticket 208 is sent to primary SME 212 (more specifically, to a computer system used by primary SME 212, such as one of the other computer(s) 152 shown in FIG. 1). However, occasions arise in which primary SME 212 is not available (e.g., is handling another trouble ticket, is on vacation, etc.). The present invention addresses this issue through the use of proxy SMEs, as described in FIG. 3.

With reference now to FIG. 3, a high-level overview of a trouble ticket handling system that uses a proxy SME is presented. As described in a similar scenario in FIG. 2, a customer client computer 302 (analogous to the customer client computer 202 shown in FIG. 2) sends a request 304 (analogous to the request 204 shown in FIG. 2) to a WMS 306 (analogous to the WMS 206 shown in FIG. 2). Assume again that the request 304 refers to Issue A, but that there are no primary SMEs (including primary SME 212 shown in FIG. 2) that are available to handle the trouble ticket 308a that is generated in response to request 304. However, a proxy Subject Matter Expert (SME) 312 is available, and thus the trouble ticket related to Issue A is sent to proxy SME 312 (or more specifically, to a computer that is used by proxy SME 312, such as one of the other computer(s) 152 depicted in FIG. 1). Proxy SME 312 is not able to handle a trouble ticket 308a related to Issue A on his own, since he only has the ability/expertise to handle trouble tickets related to Issue X. However, proxy SME 312 is part of a social media group 316, which includes an Issue A expert 314a, an Issue B expert 314b, and an Issue C expert 314c. Thus, although proxy SME 312 is unable to handle the trouble ticket 308a, he is able to consult with Issue A expert 314a, whom proxy SME 312 knows to be an expert in Issue A.

In one embodiment, membership in social media group 316 is limited to only those entities selected by proxy SME 312. For example, proxy SME 312 may select certain issue experts that proxy SME 312 has worked with on other projects, etc., and thus knows that they are appropriate resources to handle trouble tickets.

In one embodiment, membership in social media group 316 is limited to only those entities selected by WMS 306. That is, WMS 306 will data mine information about various entities, including experts 314a-314c shown in FIG. 3, and then assign them to their respective areas of expertise (A, B, C). Thereafter, WMS 306 assigns experts 314a-314c to the social media group 316, and then assigns that social media group 316 to proxy SME 312, in order to assist proxy SME 312 in handling trouble tickets (e.g., related to Issues A, B, C) that he/she is unable to handle on his/her own.

Since social media group 316 includes experts 314a-314c in corresponding Issues A-C, then proxy SME 312 is able to handle, through consultations with and/or referrals to experts 314a-314c, trouble tickets 308a-308c. For example, in one embodiment, proxy SME 312 receives the trouble ticket 308a regarding Issue A, gets advice from expert 314a on how to handle the trouble ticket 308a, and then proxy SME 312 communicates a solution back to the customer on customer client computer 302. In another embodiment/example, however, proxy SME 312 sends the trouble ticket 308a (which includes contact information for the customer making the request 304) to expert 314a, who then responds directly to the customer by providing a solution to Issue A.

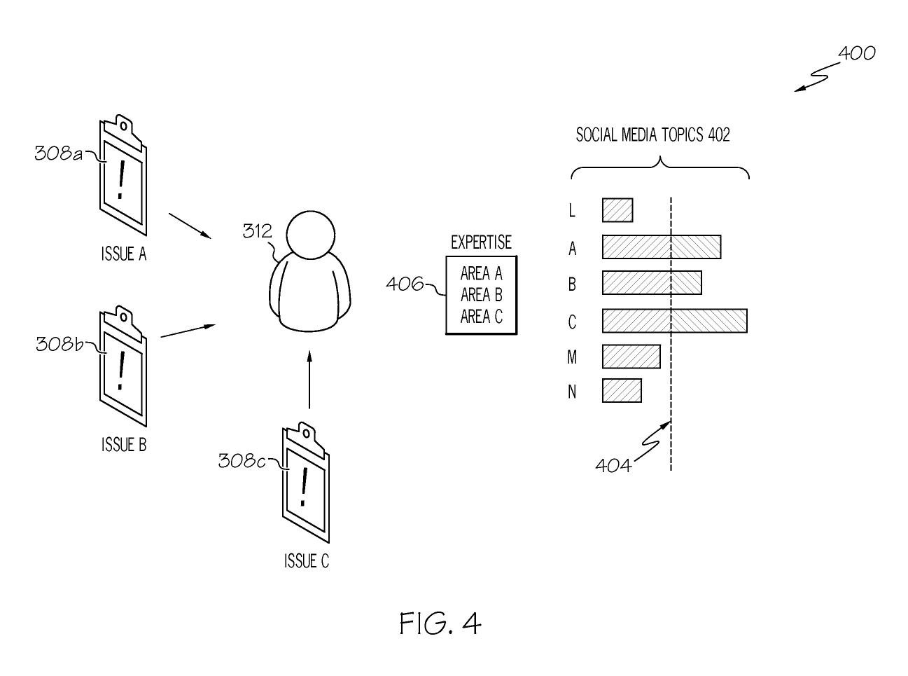

Rather than requiring proxy SME 312 to remember what areas of expertise are held by members of his social media group 316, WMS 306 determines what areas of expertise each of the peers (i.e., experts 314a-314c) in social media group 316 hold. In one embodiment, this is accomplished by interrogating a database that simply includes a profile of each of the experts 314a-314c, including their areas of expertise. In another embodiment, however, WMS 306 data mines information associated with the experts 314a-314c in order to determine what their respective areas of expertise are. For example, consider the data mining described in FIG. 4.

FIG. 4 illustrates an exemplary process for defining proxy expertise based on incidence rates of posts by members (i.e., experts 314a-314c) of the social media group 316 depicted in FIG. 3. A post is an entry into a chat board, shared webpage, etc. that is used by members of social media group 316. For example, in depiction 400 there are multiple social media topics 402, which are related to posts by the experts 314a-314c. Assume that these topics include topics relevant to Issues A-C (discussed above), as well as topics related to other Issues L, M, N. As illustrated in depiction 400, posts related to Issues A-C exceed a predetermined level, as indicated by the vertical dashed line 404. Line 404 may indicate either a raw score (i.e., how many posts related to a particular issue have been made during some predetermined amount of time), or they may be weighted. If weighted, such weightings may be based on criteria that are derived: 1) according to the poster (i.e., person who submitted a post to a content sharing platform, such as a social media webpage); 2) according to the content of the post; 3) according to the time of the post; 4) according to activities being performed by the poster at the time of the post; and/or 5) according to whether the post was by one member or by multiple members (experts 314a-314c) of the social media group 316.

For example and with reference to criterion (1), if a poster of the content shared by the social media group 316 has a profile showing that he has been predefined as an expert in Issue A but not in Issue B, then any posts about Issue A by that poster are given more weight than his/her posts about Issue B.

With reference to criterion (2), if a particular post has been peer-reviewed and given a strong review (e.g., by a number of “Like” responses indicating that they agree with the post), then that post will be given a higher weighting than a post that has not been favorably received.

With reference to criterion (3), a particular post that was made within the past month would be weighted heavier than a post that was posted ten years ago. That is, a person's level of expertise in a particular area, and thus the significance of his/her posts regarding that particular area, is assumed to decrease over time, since the poster is no longer actively posting in that particular area (thus indicating a drop in activity by that poster regarding that particular area).

With reference to criterion (4), activities being performed by the poster at the time of the post affect the weighting of his/her posts. For example, assume that a poster is working on a project related to Issue A when he filed a post on a social media website. This post has a greater weight than a post that, although related to Issue A, was made while the poster was working on a project that was unrelated to Issue A. That is, if a person was in the act of working on a project, doing research, writing a paper, presenting a seminar, etc. related to Issue A at the time of the post, then an assumption is made that whatever he/she posted at that time is significant, and thus deserves a high weight. However, if the person was working on an unrelated issue (i.e., Issue X) at the time of the posting related to Issue A, then an assumption is made that the posting does not reflect the most current state of the art regarding Issue A, since the poster was devoting his attention to Issue X, and not Issue A, at the time of the post.

With reference to criterion (5), a post is weighted according to whether the post was by one member or by multiple members (experts 314a-314c) of the social media group 316. That is, if a post about Issue A came from only one of the members of the social media group 316 (e.g., expert 314a), then that posting is weighted lower than if the post about Issue A was co-authored by multiple experts (particularly those with known expertise in Issue A within the social media group 316), since the post was collaborative and thus inherently peer-reviewed.

Note that the social media topics 402 and their quantity of postings depicted in FIG. 4 may be for: (a) a single member of the social media group 316; (b) a group of members of the social media group 316 (e.g., all members deemed to be experts in a particular area); and/or (c) all members of the social media group 316.

With reference to scenario (a), breaking out the quantity (weighted or unweighted) of posts for a particular social media topic by a single member of the social media group 316 will indicate what areas of expertise that single member has. In the example shown in depiction 400, assume that A-C and L-M identify topics that a particular member of the social media group 316 has posted on. Since this particular member has posted on Topics/Issues/Areas A, B, and C more than the predetermined threshold indicated by line 404, then that particular member is deemed to be an expert in Topics/Issues/Areas A, B, and C.

With reference to scenario (b), assume that a group of members of the social media group 316 (e.g., a subgroup that includes all members deemed to be experts in a particular area) post entries related to Topics/Issues/Areas A, B, and C as well as Topics/Issues/Areas L, M, and N. Collectively, this subgroup is deemed to have collective expertise (i.e., by utilizing them together as a subgroup to handle a particular trouble ticket) related to Topics/Issues/Areas A, B, and C, since together they have posted more than the predetermined threshold indicted by line 404 for Topics/Issues/Areas A, B, and C. However, since the quantity of posts related to Topics/Issues/Areas L, M, and N has not exceeded the predetermined threshold indicated by line 404, then this subgroup, even working together, are not considered to be experts in Topics/Issues/Areas L, M, and N.

With regards to scenario (c) all members of the social media group 316, a similar analysis for the collective level of expertise for all members of the social media group 316 is used for the subgroup discussed in scenario (b).

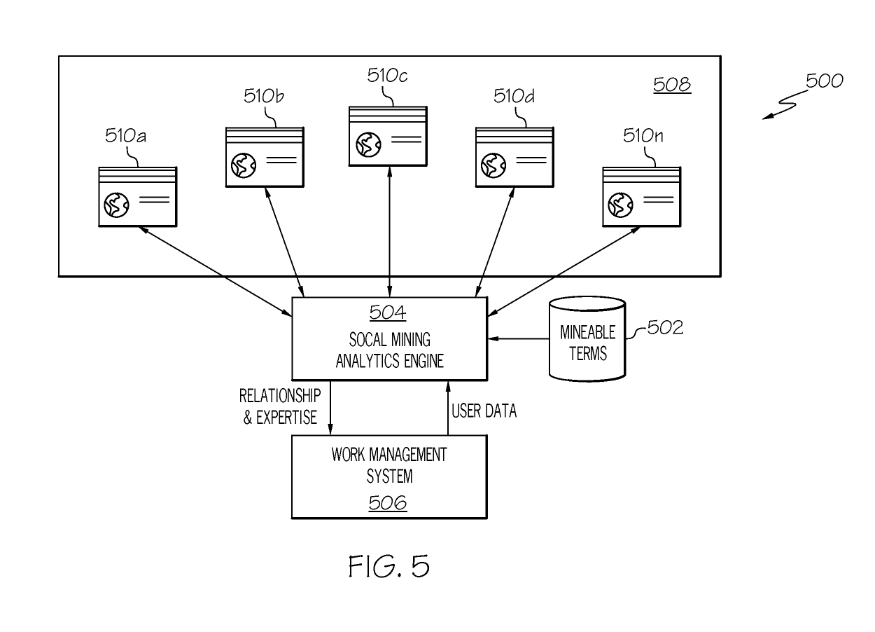

With reference now to FIG. 5, additional detail of data mining of social media posts to identify certain areas of expertise is presented in system 500. System 500 includes a Work Management System (WMS) 506, which drives work and assessments of tickets, works and problem records to individuals, as described above for WMS 206 in FIG. 2 and WMS 306 in FIG. 3. System 500 also includes a Social Mining Analytics Engine (SMAE) 504. SMAE 504 takes user data from the WMS 506 as well as mineable terms (from database 502) and processes data from Social Media Sites (SMS) 508. That is, SMS 508 provide multiple webpages 510a-510n (where “n” is an integer), each of which contains posts from one or more of the members of a social media group, such as experts 314a-314c shown in social media group 316 in FIG. 3. WMS 506 extracts words/phrases from these webpages 510a-510n for comparison with the mineable terms, which are from the database 502 of terms that are associated with technologies that the WMS 506 manages. The SMS 508 is a collection of social media sites and news groups, both public (i.e., available to any invited person from the public) as well as private (e.g., available only to members of an enterprise, etc.).

In one embodiment of the present invention, data mining posts and other social media content of potential peer experts utilizes the following steps.

Step (1). The Social Mining Analytics Engine (SMAE) 504 queries the Work Management System (WMS) 506 and pulls in the next batch of users to inspect. The system 500 may also pull in additional social media sites with credentials.

Step (2). The SMAE queries database 502 and pulls in a fresh list of terms that should be considered along with the corresponding concept. This can be any technical or non-technical terms. Since a user is linked to a Skill Concept such as Networking, terms such as “IPSec Tables”, “Natted IP Address”, “Socket”, “Packet Filtering” will correspond to a concept called “Networking”.

Step (3). SMAE 504 then cycles through the available sites from SMS 508.

Step (4). For each site in SMS 508, SMAE 504 cycles through the users of each site that the SMAE 504 tracks.

Step (5). SMAE 504 connects to a current site and pulls a list of recent (since the last inspection) posts created for a user. The SMAE 504 now has a series of social media posts for a given user for a given site.

Step (6). At this point, SMAE 504 applies a matching algorithm that compares the posts to a database of terms in an attempt to understand which (if any) Skill Concepts might have been discussed in the post.

Step (7). If the terms match, SMAE 504 applies a peer acknowledgement signature to understand if any other users of that site have “liked”, “bumped”, referenced, or shared the information and if so, how many times. The more times a particular post is acknowledged, the more weight this post carries.

Step (8). Based on the information in Steps (6) and (7), a score is calculated for each Skill Concept that can be identified.

Step (9). SMAE 504 updates the user's record to incorporate the new score with any previous scores for the given concept.

Step (10). SMAE 504 compares the total score (i.e., the previous score augmented by the current weight) to a threshold for a given concept to determine if this user should or should not be considered “skilled” in the given concept. For example, if a user has been posting over the course of a month about a given network topic, and with this most recent inspection, they now have a Network Concept skill of 300, that may cross the threshold and the user should be upgraded from a level 2 skill at networking to a level 3.

Step (11). SMAE 504 updates the work management system (WMS 506) with the user's new skill rating for a given Concept and moves on to the next matched term.

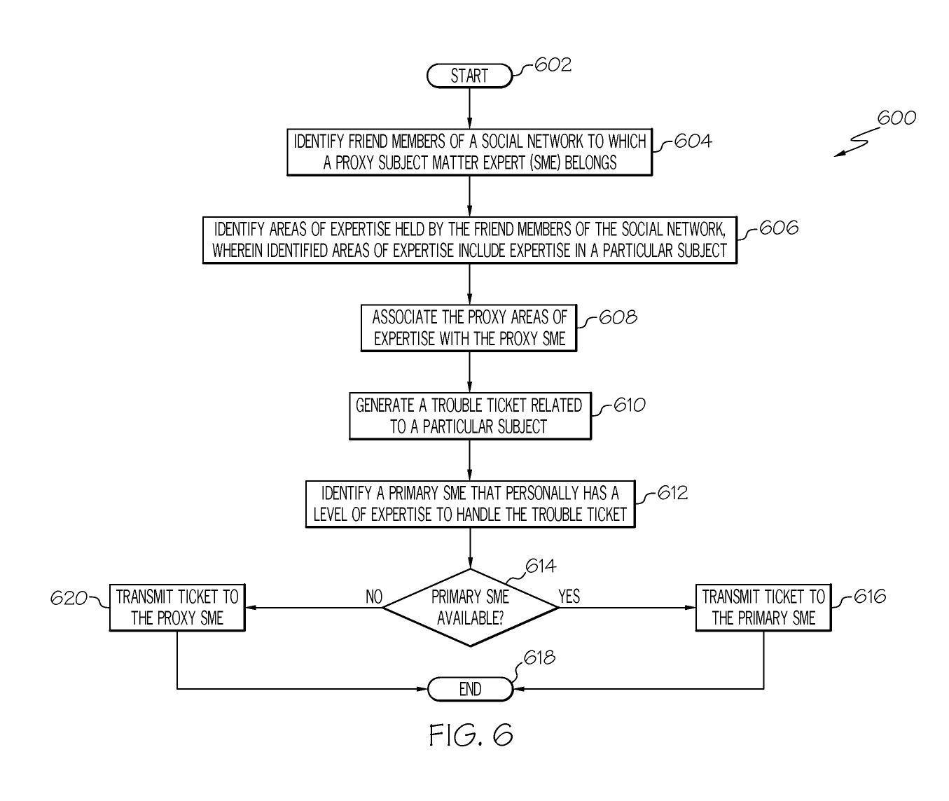

With reference now to FIG. 6, a high level flow-chart of one or more operations performed by one or more processors to direct trouble tickets to either a primary Subject Matter Expert (SME) or a proxy Subject Matter Expert (SME) in a service unit is presented.

After initiator block 602, friend members of a social network group to which a proxy Subject Matter Expert (SME) belongs are identified (block 604) In one embodiment, only the friend members and the proxy SME are members of this social network group.

As described in block 606, areas of expertise held by the friend members of the social network group are identified, either by data mining their entries on social media sites or by reviewing their profiles. The identified areas of expertise include expertise in a particular subject (e.g., Areas/Issues/Fields A-C, as described above).

As described in block 608, the areas of expertise, held by the friend members of the social network group, are then associated with the proxy SME. For example, in FIG. 3, proxy SME 312 is associated with the areas of expertise related to issues A, C, and C, due to the relationship that proxy SME 312 with experts 314a-314c in their shared social media group 316.

As described in block 610, a trouble ticket related to a particular subject is generated (e.g., in response to receiving a request from a customer, such as the request 304 depicted in FIG. 3).

As described in block 612, a primary SME (e.g., primary SME 212 depicted in FIG. 2) that personally has a level of expertise to handle that trouble ticket is identified. If such a primary SME is available (query block 614), then the trouble ticket is sent to that primary SME for handling. However, if such a primary SME is not available (again, query block 614), then the trouble ticket is transmitted to the proxy SME for handling by one or more of the friend members from the social network group to which the proxy SME belongs. The process ends at terminator block 618.

In one embodiment of the present invention, a subgroup of friends from the friend members of the social network group is identified. In one embodiment, this subgroup of friends is made up of persons who have all worked on past projects with the proxy SME, thus giving the proxy SME an assurance that any member of this subgroup is capable of handling the trouble ticket, and/or will be compatible with the customer. Based on these criteria, the trouble ticket is then transmitted only to this subgroup of friends.

In one embodiment of the present invention, the trouble ticket is transmitted from a work management system (e.g., WMS 306 described above with FIG. 3). In this embodiment, identities of the friend members of the social network group that the proxy SME will be fronting for are hidden. In one embodiment, these identities are hidden from the work management system. In one embodiment, these identities are hidden from the customer.

In one embodiment of the present invention, the areas of expertise held by the friend members of the social network group are identified by data mining entries, made by the friend members of the social network group, on a shared message board used by the social network group (e.g., as described in FIG. 4 and FIG. 5). In one embodiment, this shared message board is for an exclusive use of the friend members and the proxy SME.

In one embodiment of the present invention, a trouble ticket is generated for a particular problem. In this embodiment, the trouble ticket is parsed into multiple sub-tickets, where each sub-ticket addresses a subcomponent issue of the particular problem. That is, assume that the request from the customer (and the resulting trouble ticket) is for a server that won't boot up. However, an examination of signals from the monitored system (e.g., monitored system 203 being monitored by customer client computer 302 in FIG. 3) reveals that there are three sub-issues: A—a corrupted BIOS; B—a broken power supply; and C—a defective memory module. Assume further that, in FIG. 3, expert 314a is an expert in Issue A (BIOS issues), expert 314b is an expert in Issue B (power supplies), and expert 314c is an expert in Issue C (memory modules). As such, the Work Management System (e.g., WMS 306 shown in FIG. 3) breaks the original trouble ticket into three sub-tickets, one for Issue A, one for Issue B, and one for Issue C, such that each of the sub-tickets are assigned to a different member (e.g., expert 314a or expert 314b or expert 314c) of the friend members of the social network group according to the issue handled by the particular sub-ticket.

In one embodiment of the present invention, the trouble ticket is assigned to the proxy SME to be handled personally by the proxy SME. That is, the proxy SME will still consult with his peers within the social media group, but all communications with the customer are by the proxy SME.

In one embodiment of the present invention, a proxy area of expertise is defined for the proxy SME as comprising the areas of expertise held by the friend members of the social network group. For example, as shown in FIG. 3, proxy SME 312 is deemed to have expertise in Issues A, B, and C, even though he really doesn't. However, he does have a relationship with experts 314a-314c, and thus their expertise in Issues A, B, and C are imparted to proxy SME 312 (through consultations with proxy SME 312, or by “stepping into the shoes” of the proxy SME 312 to handle the trouble ticket).

In one embodiment of the present invention, the proxy area of expertise assigned to proxy SME is modified according to a quantity of social media topic entries posted by the friend members of the social network group. That is, the more posts made by the peers within the proxy SME's social group on a particular subject, the greater the level of “proxy expertise” is given to the proxy SME.

In one embodiment of the present invention, the primary SME is from a plurality of SMEs that all have expertise in the particular subject. In this embodiment, all of the other SMEs are interrogated for current real-time availability. If none of the primary SMEs from the plurality of SMEs are available, then the trouble ticket is sent to the proxy SME.

In one embodiment of the present invention, the trouble ticket is generated in response to a customer transmitting a request for service to a work management hardware system, where the customer transmitted the request from a client hardware device, and where a response to the request for service will be handled by an electronic communication between the customer and at least one service computer used by at least one of the friend members of the social network group. That is, as described above, the request is generated by a client hardware device, such as the customer client computer 302 depicted in FIG. 3. In this embodiment, there is a first interrogation of the client hardware device by the work management hardware system. This first interrogation identifies a hardware system used by the client hardware device for electronic communications. The work management hardware system then performs a second interrogation of the service computer that is used by one of the peers experts in the social media group (e.g., one or experts 314a-314c depicted in FIG. 3). This second interrogation identifies a hardware system used by the service computer for electronic communications. A comparison is then made (in one embodiment by the work management hardware system) of the communication hardware used by the client hardware device with communication hardware used by the service computer. Based on this comparison, transmission of the trouble ticket from the work management hardware system to the service computer is restricted to service computers whose communication hardware matches that of the client hardware device.

As described herein, the present invention utilizes social media to build a profile of incident resolvers based on mining social media posts (including, but not limited to sites such as public social media websites, internal social media sites, message boards, etc.). In one embodiment, the system mines social media posts and maintains an index of technical terms, which leads to primary specialization for certain individuals. This allows the new concept of a “specialization by proximity” to become available. This “specialization by proxy” allows a service center to search for Subject Matter Experts (SMEs) not only within its primary tier1/2/3 agents, but also to make use of their associates' knowledge. Thus in one embodiment, if there is no primary resource available for a given technology, the trouble ticket is routed to a proxy SME that has an associate that is an expert in that field. Based on the usage of social networking, the amount and complexity of issues that can be assigned to that proxy SME grows exponentially based on his/her associates.

As described in the written specification and drawings herein, in one or more embodiments a specialization by proxy method/system understand an expertise of a proxy SME's peer groups and, barring any other viable primary SME candidate, route a trouble ticket to a “Specialist by proxy”. This allows the system to take advantage of knowledge of peers as well as primary SMEs, in order to route tickets and work to agents that can find the right answer, even if they do not know it themselves.

Note that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A method of handling trouble tickets in a service unit, the method comprising:
identifying, by one or more processors, friend members of a social network group to which a proxy Subject Matter Expert (SME) belongs, wherein only the friend members and the proxy SME are members of the social network group;
identifying, by one or more processors, areas of expertise held by the friend members of the social network group, wherein identified areas of expertise include expertise in a particular subject;
associating, by one or more processors, the areas of expertise, held by the friend members of the social network group, with the proxy SME;
generating, by one or more processors, a trouble ticket related to the particular subject;
identifying, by one or more processors, a primary SME that personally has a level of expertise to handle the trouble ticket; and
in response to the primary SME being unavailable, transmitting, by one or more processors, the trouble ticket to the proxy SME for handling by one or more of the friend members from the social network group to which the proxy SME belongs.

2. The method of claim 1, further comprising:
identifying, by one or more processors, a subgroup of friends, wherein the subgroup of friends are from the friend members of the social network group, and wherein the subgroup of friends have all worked on past projects with the proxy SME; and
transmitting, by one or more processors, the trouble ticket only to the subgroup of friends.

3. The method of claim 1, wherein the trouble ticket is transmitted from a work management system, and wherein the method further comprises:
hiding, by one or more processors, an identity of the friend members of the social network group.

4. The method of claim 1, further comprising:
identifying, by one or more processors, the areas of expertise held by the friend members of the social network group by data mining entries, made by the friend members of the social network group, on a shared message board used by the social network group, wherein the shared message board is for an exclusive use of the friend members and the proxy SME.

5. The method of claim 1, wherein the trouble ticket is for a particular problem, and wherein the method further comprises:
parsing, by one or more processors, the trouble ticket into multiple sub-tickets, wherein each sub-ticket addresses a subcomponent issue of the particular problem; and
assigning, by one or more processors, each of the multiple sub-tickets to a different member of the friend members of the social network group.

6. The method of claim 1, further comprising:
assigning, by one or more processors, the trouble ticket to the proxy SME to be handled exclusively by the proxy SME.

7. The method of claim 1, further comprising:
defining, by one or more processors, a proxy area of expertise for the proxy SME as comprising the areas of expertise held by the friend members of the social network group.

8. The method of claim 7, further comprising:
modifying, by one or more processors, the proxy area of expertise according to a quantity of social media topic entries posted by the friend members of the social network group.

9. The method of claim 1, wherein the primary SME is from a plurality of SMEs that have expertise in the particular subject, and wherein the method further comprises:
interrogating, by one or more processors, all of the plurality of SMEs for current real-time availability; and
in response to determining, based on said interrogating, that all of the plurality of SMEs are currently unavailable, transmitting, by one or more processors, the trouble ticket to the proxy SME.

10. The method of claim 1, wherein the trouble ticket is generated in response to a customer transmitting a request for service to a work management hardware system, wherein the customer transmits the request from a client hardware device, wherein a response to the request for service will be handled by an electronic communication between the customer and at least one service computer used by at least one of the friend members of the social network group, and wherein the method further comprises:
first interrogating, by one or more processors, the client hardware device by the work management hardware system, wherein said first interrogating identifies a hardware system used by the client hardware device for electronic communications;
second interrogating, by one or more processors, the service computer by the work management hardware system, wherein said second interrogating identifies a hardware system used by the service computer for electronic communications;
comparing, by one or more processors, communication hardware used by the client hardware device with communication hardware used by the service computer; and
restricting, by one or more processors, transmission of the trouble ticket from the work management hardware system to the service computer to service computers whose communication hardware matches that of the client hardware device.

11. A computer program product for handling trouble tickets in a service unit, the computer program product comprising a computer readable storage medium having program code embodied therewith, the program code readable and executable by a processor to perform a method comprising:
identifying friend members of a social network group to which a proxy Subject Matter Expert (SME) belongs, wherein only the friend members and the proxy SME are members of the social network group;
identifying areas of expertise held by the friend members of the social network group, wherein identified areas of expertise include expertise in a particular subject;
associating the areas of expertise, held by the friend members of the social network group, with the proxy SME;
generating a trouble ticket related to the particular subject;
identifying a primary SME that personally has a level of expertise to handle the trouble ticket; and
in response to the primary SME being unavailable, transmitting the trouble ticket to the proxy SME for handling by one or more of the friend members from the social network group to which the proxy SME belongs.

12. The computer program product of claim 11, wherein the method further comprises:
identifying a subgroup of friends, wherein the subgroup of friends are from the friend members of the social network group, and wherein the subgroup of friends have all worked on past projects with the proxy SME; and
transmitting the trouble ticket only to the subgroup of friends.

13. The computer program product of claim 11, wherein the trouble ticket is transmitted from a work management system, and wherein the method further comprises:
hiding an identity of the friend members of the social network group.

14. The computer program product of claim 11, wherein the trouble ticket is for a particular problem, and wherein the method further comprises:
parsing the trouble ticket into multiple sub-tickets, wherein each sub-ticket addresses a subcomponent issue of the particular problem; and
assigning each of the multiple sub-tickets to a different member of the friend members of the social network group.

15. The computer program product of claim 11, wherein the trouble ticket is generated in response to a customer transmitting a request for service to a work management hardware system, wherein the customer transmits the request from a client hardware device, wherein a response to the request for service will be handled by an electronic communication between the customer and at least one service computer used by at least one of the friend members of the social network group, and wherein the method further comprises:
first interrogating the client hardware device by the work management hardware system, wherein said first interrogating identifies a hardware system used by the client hardware device for electronic communications;
second interrogating the service computer by the work management hardware system, wherein said second interrogating identifies a hardware system used by the service computer for electronic communications;
comparing communication hardware used by the client hardware device with communication hardware used by the service computer; and
restricting transmission of the trouble ticket from the work management hardware system to the service computer to service computers whose communication hardware matches that of the client hardware device.

16. A computer system comprising:
a processor, a computer readable memory, and a computer readable storage medium;
first program instructions to identify friend members of a social network group to which a proxy Subject Matter Expert (SME) belongs, wherein only the friend members and the proxy SME are members of the social network group;
second program instructions to identify areas of expertise held by the friend members of the social network group, wherein identified areas of expertise include expertise in a particular subject;
third program instructions to associate the areas of expertise, held by the friend members of the social network group, with the proxy SME;
fourth program instructions to generate a trouble ticket related to the particular subject;
fifth program instructions to identify a primary SME that personally has a level of expertise to handle the trouble ticket; and
sixth program instructions to, in response to the primary SME being unavailable, transmit the trouble ticket to the proxy SME for handling by one or more of the friend members from the social network group to which the proxy SME belongs; and wherein
the first, second, third, fourth, fifth, and sixth program instructions are stored on the computer readable storage medium and executed by the processor via the computer readable memory.

17. The computer system of claim 16, further comprising:
seventh program instructions to identify a subgroup of friends, wherein the subgroup of friends are from the friend members of the social network group, and wherein the subgroup of friends have all worked on past projects with the proxy SME; and
eighth program instructions to transmit the trouble ticket only to the subgroup of friends; and wherein
the seventh and eighth program instructions are stored on the computer readable storage medium and executed by the processor via the computer readable memory.

18. The computer system of claim 16, wherein the trouble ticket is transmitted from a work management system, and wherein the system further comprises:
seventh program instructions to hide an identity of the friend members of the social network group; and wherein
the seventh program instructions are stored on the computer readable storage medium and executed by the processor via the computer readable memory.

19. The computer system of claim 16, wherein the trouble ticket is for a particular problem, and wherein the system further comprises:
seventh program instructions to parse the trouble ticket into multiple sub-tickets, wherein each sub-ticket addresses a subcomponent issue of the particular problem; and
eighth program instructions to assign each of the multiple sub-tickets to a different member of the friend members of the social network group; and wherein
the seventh and eighth program instructions are stored on the computer readable storage medium and executed by the processor via the computer readable memory.

20. The computer system of claim 16, wherein the trouble ticket is generated in response to a customer transmitting a request for service to a work management hardware system, wherein the customer transmits the request from a client hardware device, wherein a response to the request for service will be handled by an electronic communication between the customer and at least one service computer used by at least one of the friend members of the social network group, and wherein the system further comprises:
seventh program instructions to first interrogate the client hardware device by the work management hardware system, wherein said first interrogating identifies a hardware system used by the client hardware device for electronic communications;
eighth program instructions to second interrogate the service computer by the work management hardware system, wherein said second interrogating identifies a hardware system used by the service computer for electronic communications;
ninth program instructions to compare communication hardware used by the client hardware device with communication hardware used by the service computer; and
tenth program instructions to restrict transmission of the trouble ticket from the work management hardware system to the service computer to service computers whose communication hardware matches that of the client hardware device; and wherein
the seventh, eighth, ninth, and tenth program instructions are stored on the computer readable storage medium and executed by the processor via the computer readable memory.
